(19) United States
(12) Patent Application Publication
(10) Pub. No.: US 2016/0210476 A1
(43) Pub. Date: Jul. 21, 2016

(54) METHOD AND APPARATUS FOR PREVENTING LEAKAGE OF INFORMATION

(71) Applicant: MARKANY INC., Seoul (KR)

(72) Inventors: Sung Gon MUN, Seoul (KR); Min Ji JO, Daejeon (KR); Jong Uk CHOI, Seoul (KR)

(21) Appl. No.: 15/002,086

(22) Filed: Jan. 20, 2016

(30) Foreign Application Priority Data
Jan. 20, 2015 (KR) 10-2015-0009213

(51) Int. Cl. G06F 21/62; G06F 3/0488; G06F 21/36

(52) U.S. Cl. CPC G06F 21/6245; G06F 21/36; G06F 3/0488

(57) ABSTRACT

Disclosed herein are a method and apparatus for preventing the leakage of information. A method for preventing the leakage of information, which is performed by an apparatus for preventing the leakage of information may include determining whether confidential information is included in content displayed on a screen of a device, covering the confidential information by overlaying a security layer on at least some of the content displayed on the screen based on the determination, displaying the confidential information by releasing the security layer covering the confidential information in response to a confidential information exposure request signal, and covering the confidential information by overlaying the security layer in response to the release of the confidential information exposure request signal.

Priority to Korean Patent Application No. 10-2015-0009213 filed on Jan. 20, 2015, the entire disclosure of which is incorporated by reference herein, is claimed.

### BACKGROUND OF THE INVENTION

1. Field of the Invention

The present invention relates to a method and apparatus for preventing the leakage of information and, more particularly, to an information protection technology in which the illegal leakage of information displayed on a screen of a device can be prevented.

2. Discussion of the Related Art

Recently, as ultra-high speed wireless communication infrastructure is constructed and various digital wireless devices come into use, tasks performed through an existing stationary terminal, such as a PC, have become able to be performed through a portable terminal. In particular, the use of smart terminals, such as smart pads or smart phones, tends to be explosively increased recently because the smart terminal advantageously provides portability, that is, the greatest advantage of a portable terminal, has performance no less than the PC, and has a much wider screen size than before.

A portable terminal is advantageous in that it can provide new and convenient types of services which could not be provided by existing stationary devices because the portable terminal can be carried and used by a user anywhere and at any time. In contrast, a portable terminal is equipped with various functions almost the same as those of the PC, which enables various information to be easily accessed and obtained. Accordingly, a possibility that an intended or unintended leakage of information through a portable terminal may occur has been increased.

For example, many services for displaying document that requires information security, such as confidential document, certificates, and identifications, on a screen of a terminal are recently provided. In this case, there is a good possibility that the leakage of information attributable to the capturing, printing and/or direct viewing of unapproved information may occur. Accordingly, there is a need for a system capable of preventing such illegal leakage of information. In line with such a need, there are suggested techniques using various methods for preventing the illegal leakage of information. For example, Korean Patent Application Publication No. 2012-0128314 discloses an apparatus and method for preventing a captured image from illegally leaking from a terminal.

The leakage of information through the capturing or printing of a screen can be prevented through various solutions, but information inevitably leaks out if an unapproved user secretly views or photographs confidential document directly when the confidential document is displayed on a screen.

A system for protecting a screen of an application by applying a screen capturing prevention profile using Mobile Device Management (MDM) technology provided by Apple to a terminal is recently provided as a scheme for preventing the leakage of a screen in iPhone. The system is problematic in that it cannot provide many and unspecified persons with a service providing a screen leakage prevention function and that it is not suitable for selectively preventing only a screen according to a specific application because information about a corresponding iPhone must be previously registered with an MDM server in order to install a screen capturing prevention profile in the corresponding iPhone.

### SUMMARY OF THE INVENTION

Accordingly, the present invention has been made keeping in mind the above problems occurring in the prior art, and an object of the present invention is to provide a method and apparatus for preventing the leakage of information, which can prevent the leakage of information by protecting at least some of content, displayed on a screen of a device, based on a security layer.

An aspect of the present invention provides a method for preventing information leakage. The method for preventing information leakage includes determining whether confidential information is included in content displayed on a screen of a device, covering the confidential information by overlaying a security layer on at least some of the content displayed on the screen based on the determination, displaying the confidential information by releasing the security layer covering the confidential information in response to a confidential information exposure request signal, and covering the confidential information by overlaying the security layer in response to the release of the confidential information exposure request signal.

Determining whether the confidential information is included in the content may include determining whether the confidential information is included in the content based on at least one of a confidential information table associated with the content and the metadata of the content.

The confidential information exposure request signal may include a signal to detect that a user touches the security layer covering the confidential information in a touch screen or a signal to detect that a user touches a specific portion of a screen displayed on a touch screen.

The release of the confidential information exposure request signal may include that the user releases the touch on the security layer covering the confidential information in the touch screen or that the user releases the touch on the specific portion. In the state in which the security layer is released in response to the touch of the user and the confidential information remains exposed to a screen, if the touch continues to remain, the exposure of the confidential information may continue.

The method for preventing the leakage of information may further include covering the confidential information by overlaying the security layer when a screen leakage detection signal is detected in the state in which the confidential information has been displayed. The screen leakage detection signal may include a signal to detect a protocol event having a danger of mirroring. The security layer may include an opaque or semi-transparent layer capable of covering the screen.

Another aspect of the present invention provides an apparatus for preventing the leakage of information. The apparatus for preventing information leakage includes a determination unit configured to determine whether confidential information is included in content displayed on a screen of a device and a security processing unit configured to cover the confidential information by overlaying a security layer on at least some of the content displayed on the screen based on the determination, display the confidential information by releasing the security layer covering the confidential information in response to a confidential information exposure request signal, and cover the confidential information by overlaying the security layer in response to the release of the confidential information exposure request signal.

The determination unit may determine whether the confidential information is included in the content based on at least one of a confidential information table associated with the content and the metadata of the content. The confidential information exposure request signal may include a signal to detect that a user touches the security layer covering the confidential information in a touch screen or a signal to detect that a user touches a specific portion of a screen displayed on a touch screen.

The release of the confidential information exposure request signal may include that the user releases the touch on the security layer covering the confidential information in the touch screen or that the user releases the touch on the specific portion. In the state in which the security layer is released in response to the touch of the user and the confidential information remains exposed to a screen, if the touch continues to remain, the exposure of the confidential information continues.

The security processing unit may cover the confidential information by overlaying the security layer when a screen leakage detection signal is detected in the state in which the confidential information has been displayed. The screen leakage detection signal may include a signal to detect a protocol event having a danger of mirroring. The security layer may include an opaque or semi-transparent layer capable of covering the screen.

Yet another aspect of the present invention provides a method for preventing information leakage. The method for preventing information leakage is performed by the apparatus for preventing information leakage, and includes overlaying a security layer on confidential information so that the confidential information is covered when the confidential information is displayed on a screen of a device, releasing the security layer when a touch event is detected in a position of a touch screen corresponding to the security layer, and overlaying the security layer on the confidential information when the touch event is released or a screen leakage signal is detected in the state in which the security layer has been released.

Further yet another aspect of the present invention provides a device. The device may include a touch screen and an application for displaying content on the touch screen, overlaying a security layer on confidential information so that the confidential information is covered when the confidential information is displayed, releasing the security layer when a touch event is detected in a position of the touch screen corresponding to the security layer, and overlaying the security layer on the confidential information when the touch event is released or a screen leakage signal is detected in the state in which the security layer has been released.

Still yet another aspect of the present invention provides a program loaded onto the memory of a computer and executed by a processor. The program may include a control unit configured to display content on a screen and an information leakage prevention unit configured to overlay a security layer on confidential information so that the confidential information is covered when the confidential information is displayed on a screen of a device by the control unit, release the security layer when a touch event is detected in a position of the touch screen corresponding to the security layer, and overlay the security layer on the confidential information when the touch event is released or a screen leakage signal is detected in the state in which the security layer has been released.

### BRIEF DESCRIPTION OF THE DRAWINGS

FIG. 1 is a block diagram showing the configuration of an apparatus for realizing a method for preventing the leakage of information in accordance with an embodiment of the present invention.

FIG. 2 is a flowchart illustrating a method for preventing the leakage of information in accordance with an embodiment of the present invention based on the configuration shown in FIG. 1.

FIG. 3 is an exemplary diagram showing the state in which a security layer has been overlaid on confidential document.

FIG. 4 is an exemplary diagram showing the state in which confidential information is exposed to a screen when the security layer overlaid on confidential document is removed.

FIG. 5 is an exemplary diagram showing the state in which the security layer has been overlaid on confidential document again because a touch event was released.

### DETAILED DESCRIPTION OF THE EMBODIMENTS

The present invention may be modified in various ways and may be implemented to have several embodiments. Specific embodiments are illustrated in the drawings and are described in detail. It is however to be understood that the present invention is not intended to be limited to the specific embodiments and the present invention includes all modifications, equivalents, and substitutions which fall within the spirit and technical scope of the present invention.

Terms, such as the first and the second, may be used to describe various elements, but the elements should not be restricted by the terms. The terms are used to only distinguish one element from the other element. For example, a first element may be named a second element without departing from the scope of the present invention. Likewise, a second element may be named a first element. The term “and/or” includes a combination of a plurality of related and illustrated items or any one of a plurality of related and described items.

When it is said that one element is “connected” or “coupled” to the other element, it should be understood that one element may be directly connected or coupled” to the other element, but a third element may exist between the two elements. In contrast, when it is described that one element is “directly connected” or “directly coupled” to the other element, it should be understood that a third element does not exist between the two elements.

The terms used in this application are used to only describe specific embodiments and are not intended to restrict the present invention. An expression of the singular number includes an expression of the plural number unless clearly defined otherwise in the context. In this application, terms, such as “comprise” or “have”, are intended to designate that characteristics, numbers, steps, operations, elements, or parts which are described in the specification, or a combination of them exist, and should not be understood that they exclude the existence or possible addition of one or more other characteristics, numbers, steps, operations, elements, parts, or combinations of them in advance.

Unless defined otherwise, all terms used herein, including technical terms or scientific terms, have the same meanings as those generally understood by persons of ordinary skill in the technical field to which the present invention pertains. The terms, such as terms that are generally used and defined in dictionaries, should be construed as having meanings identical to those that are used in the context of related technology, and should not be construed as having ideal or excessively formal meanings unless explicitly defined otherwise.

Hereinafter, some embodiments of the present invention are described in more detail with reference to the accompanying drawings. In describing the present invention, in order to help general understanding, the same reference numerals are used to denote the same elements throughout the drawings, and a redundant description of the same elements is omitted.

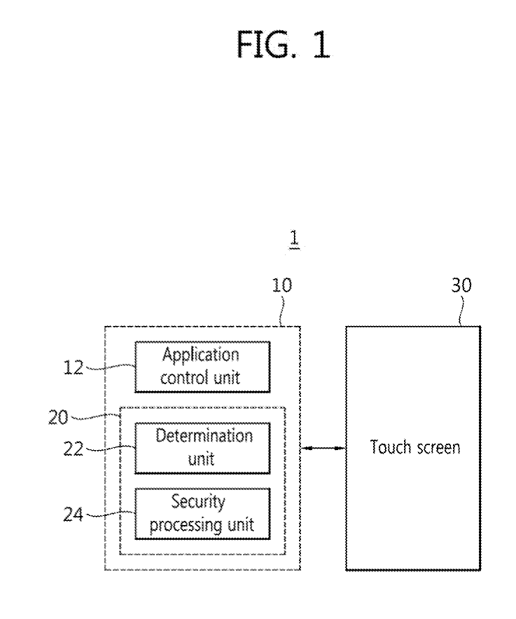

FIG. 1 is a block diagram showing the configuration of an apparatus for realizing a method for preventing the leakage of information in accordance with an embodiment of the present invention.

As shown in FIG. 1, a device 1 is provided in order to realize a method for preventing the leakage of information in accordance with an embodiment of the present invention. In the present embodiment, the device 1 is assumed to be a portable terminal, in particular, a smart phone, but is only an example. The device 1 may be a handheld portable terminal or may be a stationary terminal, such as a PC.

Although not shown, the device 1 include memory capable of storing data, a processor capable of loading applications onto the memory and executing the applications, a display device capable of displaying information, and an input device capable of inputting information. In the present embodiment, an example in which a touch screen 30 capable of inputting and displaying information in accordance with the input device and the display device is included is described.

Referring to FIG. 1, the device 1 may be equipped with an application 10 and the touch screen 30. The application 10 performs a unique function. For example, the application 10 according to the present embodiment may be at least one of all types of applications, such as a document editor, a graphic editor, game, and a web browser. The execution of the application 10 may be controlled by an application control unit 12.

In accordance with an embodiment of the present invention, the application 10 includes an information leakage prevention unit 20. The information leakage prevention unit 20 can prevent the leakage of confidential information by covering the confidential information based on a security layer if the confidential information is included in content displayed on the touch screen 30 when the application 10 is executed. That is, in an embodiment of the present invention, the leakage of confidential information included in content can be easily prevented even without a help and without a complicated association with an external server based on the information leakage prevention unit 20 included in the application 10.

The confidential information means information that must not leak out. That is, the confidential information may mean information that must be protected. For example, the confidential information may be information that must not thoughtlessly leak out to an unapproved user, such as a resident registration number, personal information, performance assessment, and secret information.

The information leakage prevention unit 20 may include a determination unit 22 and a security processing unit 24.

The determination unit 22 may determine whether confidential information is included in content displayed on the touch screen 30. For example, the determination unit 22 may determine whether confidential information is included in content to be displayed on the touch screen 30 based on a predetermined confidential information table associated with the content and/or information included in the metadata of the content. The determination unit 22 may send information required to generate the SL to the security processing unit 24 based on a result of the determination.

When content is displayed by the application 10, the security processing unit 24 generates the security layer and overlays the security layer on confidential information so that the confidential information determined by the determination unit 22 is covered. Accordingly, information that belongs to content displayed on the touch screen 30 and that requires security is protected because it is not exposed.

When a confidential information exposure request signal is received from the touch screen 30, the security processing unit 24 may display confidential information by releasing the security layer overlaid on the confidential information (i.e., removing the security layer). In the present embodiment, the confidential information exposure request signal may be a signal to touch at least part of a screen displayed on the touch screen 30.

For example, the confidential information exposure request signal may be a signal to touch the security layer displayed on the touch screen 30. In other words, when a touch event is generated in a region corresponding to the security layer, the security processing unit 24 may display confidential information by releasing the security layer that covers the confidential information. Accordingly, when a user touches the security layer displayed on the touch screen 30 or a specific portion displayed on a screen, the covered confidential information can be displayed to the user.

When the release of a confidential information exposure request signal is detected from the touch screen 30 in the state in which confidential information has been exposed in response to the confidential information exposure request signal, the security processing unit 24 may cover the confidential information again by overlaying the security layer on the confidential information. For example, when a user releases a touch on the security layer or a specific portion of a screen (e.g., when the user executes an operation for separating his or her finger or a touch pen from the touch screen) in the state in which the exposure of confidential information is maintained, the security processing unit 24 may cover the confidential information by overlaying the security layer on the confidential information.

When a screen leakage detection signal is detected in the state in which confidential information has been exposed in response to a confidential information exposure request signal, the security processing unit 24 may cover the confidential information by overlaying the security layer on the confidential information. For example, when a screen leakage detection signal is detected in the state in which the exposure of confidential information has been maintained because a user touched the security layer or a specific portion of a screen, the security processing unit 24 may cover the confidential information by overlaying the security layer on the confidential information although the user has touched the touch screen 30. The screen leakage detection signal may include a protocol event having a danger of mirroring or a signal to detect a WIFI connection, Bluetooth connection, or mirroring connection with another device.

In another embodiment of the present invention, in a device not equipped with a touch screen, a confidential information exposure request signal may be a signal to select the security layer or a specific portion of a screen using a mouse pointer a cursor or may be a signal to detect the maintenance of the pressing of a mouse button.

In this case, a request for the release of the confidential information exposure request signal may be a signal to move the mouse pointer or cursor selecting the security layer or the specific portion of the screen to another region, a signal to click on the security layer or a specific portion of the screen again in the state in which the security layer or a specific portion of the screen has been clicked on, or a signal to release the pressing of the mouse button.

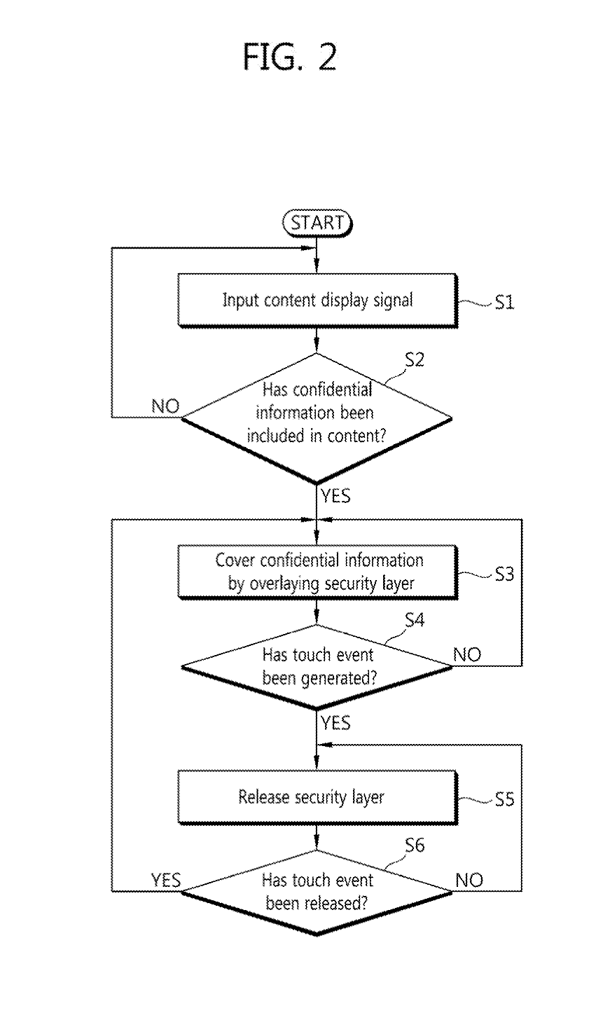

FIG. 2 is a flowchart illustrating a method for preventing the leakage of information in accordance with an embodiment of the present invention based on the configuration shown in FIG. 1.

First, it is assumed that a user tries to view confidential document using the device 1, for example, a smart phone and the confidential document includes confidential information that must not be externally exposed without permission, for example, a resident registration number.

When the user executes the application 10 and fetches the confidential document in order to view the confidential document, the application control unit 12 generates a content display signal for opening the requested confidential document. The content display signal is inputted to the information leakage prevention unit 20 at step S1.

The determination unit 22 determines whether the confidential information is included in displayed content, that is, the confidential document at step S2. The determination unit 22 may determine whether the confidential information is included in the displayed content based on a predetermined confidential information table associated with the requested content or the metadata of the content. First information indicative of whether the confidential information has been included in the content, second information indicative of a region in which the confidential information is placed, and third information indicative of the type of confidential information may have been included in the confidential information table or the metadata. The confidential information table or the metadata may have been packaged in associated with the content and stored in the device 1. If, as a result of the determination, it is determined that the confidential information has been included in the confidential document based on the first information, the determination unit 22 may send the second information and the third information to the security processing unit 24. In response thereto, the security processing unit 24 may generate the security layer capable of covering the confidential information based on the information received from the determination unit 22.

Next, when the confidential document is displayed by the application 10, the security processing unit 24 covers the confidential information by overlaying the security layer on at least part of the touch screen so that the confidential information is covered at step S3. The security processing unit 24 may cover only the confidential information of the confidential document or the entire confidential document using the second information. In the latter case, it is not necessary to extract the second information from the determination unit 22.

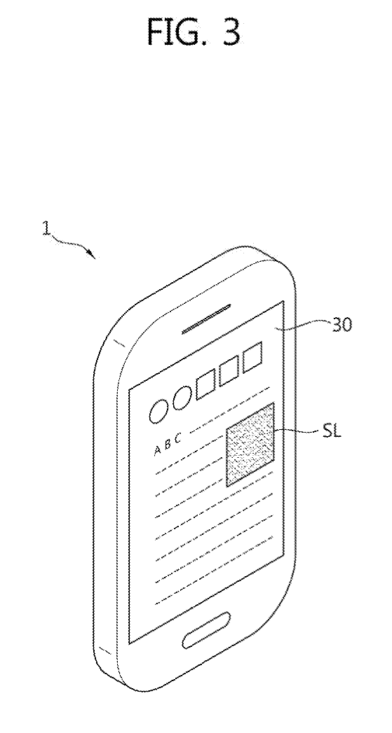

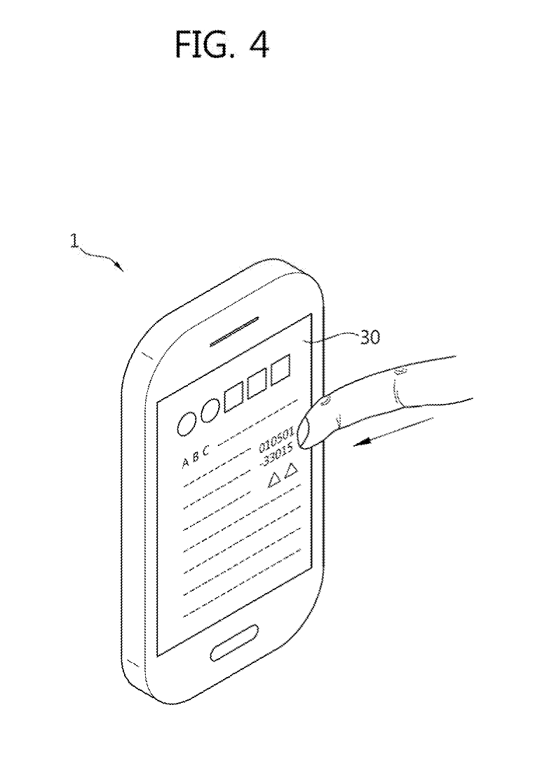

FIG. 3 is an exemplary diagram showing the state in which the security layer has been overlaid on confidential document. FIG. 4 shows an example in which only confidential information included in confidential document is targeted and covered.

As shown in FIG. 3, the security processing unit 24 of the information leakage prevention unit 20 covers the confidential information by overlaying the security layer SL on part of the screen of the confidential document displayed on the touch screen 30. Accordingly, the confidential information is not exposed to the screen displayed on the touch screen 30.

If the user tries to view the confidential information included in the confidential document in the state in which the confidential information has been covered, the user may touch the security layer or a specific portion of a screen displayed on the touch screen 30. In response to the touch, the touch screen 30 may generate a touch event at step S4. The signal of the touch event may be considered to be a confidential information exposure request signal by the security processing unit 24. When the confidential information exposure request signal is received, the security processing unit 24 may display the confidential information by releasing the security layer that covers the confidential information at step S5. FIG. 4 is an exemplary diagram showing the state in which confidential information is exposed to a screen when the security layer overlaid on confidential document is removed.

When the user touches the security layer, the security layer is removed, and thus the confidential information is exposed as shown in FIG. 4. When the user maintains a touch on a corresponding position, the confidential information remains exposed.

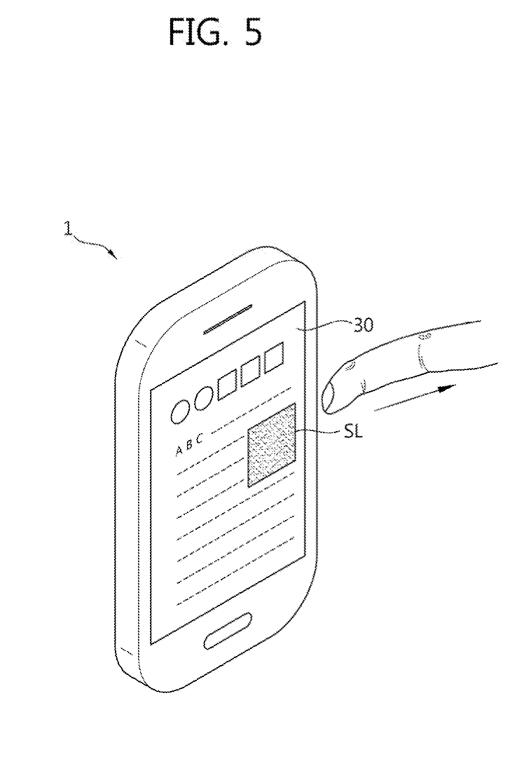

In this state, after checking the confidential information, the user may release the touch state by detaching his or her finger from the touch screen 30 at step S6. In response thereto, the touch event of the touch screen 30 is released, and the security processing unit 24 may consider it to be the release of the confidential information exposure request signal. In response to the release of the confidential information exposure request signal, the security processing unit 24 may cover the confidential information by overlaying the confidential information on the released security layer again at step S3. FIG. 5 is an exemplary diagram showing the state in which the security layer has been overlaid on confidential document again because a touch event was released.

As shown in FIG. 5, when the touch event is removed, the security processing unit 24 of the information leakage prevention unit 20 covers the confidential information by overlaying the security layer SL on part of the screen of the confidential document displayed on the touch screen 30. Accordingly, the confidential information of the content displayed on the touch screen 30 is not exposed again.

When a screen leakage detection signal is detected in the state in which a user maintains a touch on the security layer or a specific region of a screen and thus the exposure of confidential information is maintained, the security processing unit 24 may cover the confidential information by overlaying the security layer on the confidential information. The screen leakage detection signal may be a protocol event having a danger of mirroring or may be a signal to detect a WIFI connection, Bluetooth connection, or mirroring connection with other device. Accordingly, the leakage of confidential information can be prevented because the confidential information is covered again when the leakage of information attributable mirroring is detected in the state in which the confidential information has been exposed.

As described above, in accordance with the embodiments of the present invention, there are advantages in that a possibility that confidential information may leak can be significantly reduced and a user can selectively view the confidential information because the security layer covers the confidential information that belongs to information displayed on a screen and that requires security.

Although the some embodiments of the present invention have been illustrated above, those skilled in the art will appreciate that the present invention may be modified in various ways without departing from the technical contents and scope of the present invention defined in the appended claims. Accordingly, the future changes of the embodiments of the present invention will not depart from the technology of the present invention.

1. A method for preventing information leakage, which is performed by an apparatus for preventing information leakage, the method comprising:
determining whether confidential information is included in content displayed on a screen of a device;
covering the confidential information by overlaying a security layer on at least some of the content displayed on the screen based on the determination;
displaying the confidential information by releasing the security layer covering the confidential information in response to a confidential information exposure request signal; and
covering the confidential information by overlaying the security layer in response to a release of the confidential information exposure request signal.

2. The method of claim 1, wherein determining whether the confidential information is included in the content comprises determining whether the confidential information is included in the content based on at least one of a confidential information table associated with the content and metadata of the content.

3. The method of claim 1, wherein the confidential information exposure request signal comprises a signal to detect that a user touches the security layer covering the confidential information in a touch screen or a signal to detect that a user touches a specific portion of a screen displayed on a touch screen.

4. The method of claim 3, wherein the release of the confidential information exposure request signal comprises that the user releases the touch on the security layer covering the confidential information in the touch screen or that the user releases the touch on the specific portion.

5. The method of claim 3, wherein in a state in which the security layer is released in response to a touch of the user and the confidential information remains exposed to a screen, if the touch continues to remain, the exposure of the confidential information continues.

6. The method of claim 1, further comprising covering the confidential information by overlaying the security layer when a screen leakage detection signal is detected in a state in which the confidential information has been displayed.

7. The method of claim 6, wherein the screen leakage detection signal comprises a signal to detect a protocol event having a danger of mirroring.

8. The method of claim 1, wherein the security layer comprises an opaque or semi-transparent layer capable of covering the screen.

9. An apparatus for preventing leakage of information, comprising:
a determination unit configured to determine whether confidential information is included in content displayed on a screen of a device; and
a security processing unit configured to cover the confidential information by overlaying a security layer on at least some of the content displayed on the screen based on the determination, display the confidential information by releasing the security layer covering the confidential information in response to a confidential information exposure request signal, and cover the confidential information by overlaying the security layer in response to a release of the confidential information exposure request signal.

10. The apparatus of claim 9, wherein the determination unit determines whether the confidential information is included in the content based on at least one of a confidential information table associated with the content and metadata of the content.

11. The apparatus of claim 9, wherein the confidential information exposure request signal comprises a signal to detect that a user touches the security layer covering the confidential information in a touch screen or a signal to detect that a user touches a specific portion of a screen displayed on a touch screen.

12. The apparatus of claim 11, wherein the release of the confidential information exposure request signal comprises that the user releases the touch on the security layer covering the confidential information in the touch screen or that the user releases the touch on the specific portion.

13. The apparatus of claim 11, wherein in a state in which the security layer is released in response to a touch of the user and the confidential information remains exposed to a screen, if the touch continues to remain, the exposure of the confidential information continues.

14. The apparatus of claim 9, wherein the security processing unit covers the confidential information by overlaying the security layer when a screen leakage detection signal is detected in a state in which the confidential information has been displayed.

15. The apparatus of claim 14, wherein the screen leakage detection signal comprises a signal to detect a protocol event having a danger of mirroring.

16. The apparatus of claim 9, wherein the security layer comprises an opaque or semi-transparent layer capable of covering the screen.

17-19. (canceled)
